(19) United States
(12) Patent Application Publication
(10) Pub. No.: US 2009/0317087 A1
(43) Pub. Date: Dec. 24, 2009

(54) Configurable control for network device operation

(76) Inventors: Marc R. Bernard, Miramar, FL (US); Jeffrey A. Rosenwald, Frederick, MD (US); Douglas A. Atkinson, Ashburn, VA (US); Joseph D. Kralowetz, Clarksville, MD (US); Jeffrey A. Noel, Leesburg, VA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/214,450

(22) Filed: Jun. 19, 2008

(51) Int. Cl. H04B 10/00

(52) U.S. Cl. 398/135

(57) ABSTRACT

A network device can encounter operating conditions that have potential to affect upstream communications adversely for another network device, as well as for the upstream communications or hardware of the network device itself. A network device according to an example embodiment of the present invention is configured to determine when such conditions occur, and, in response, modify the behavior of the device so as to maintain the integrity of upstream communications and the network device. Network robustness is improved through the example embodiment, and fewer service calls are experienced by service providers.

### BACKGROUND OF THE INVENTION

A passive optical network (PON) can include multiple Optical Line Terminals (OLTs), each connected by a shared optical fiber to a respective Optical Distribution Network (ODN) with multiple Optical Network Terminals (ONTs) on individual optical fibers. ONTs can malfunction and interfere with communications between the ONTs and the OLT on a shared optical fiber. Such malfunctions may result from power outages or by communication systems errors or failures. If ONTs are malfunctioning, identifying the cause of the malfunction requires a technician to inspect each ONT, possibly causing costly interruptions to service.

Further challenges are caused by configuration and placement of ONTs. There is an ever increasing popularity to integrate multiple devices within the ONT. There is also a variety of deployment options for these devices, where they may be installed outdoors, sometimes in regions with extremely hot or extremely cold temperatures. There may be cases when customers install ONTs and other devices in environments that the devices themselves were not created to withstand. Alternatively, there may be random events that cause extreme temperatures that the ONT may not be able to withstand. In other cases, the ONT may not be installed properly, and the air flow within the device is not sufficient to maintain a tolerable temperature.

ONTs are also deployed indoors. When installed, these ONTs may be located in areas with extreme temperatures, or subscribers may fail to properly maintain the area of the ONT or the ONT itself. For example, a subscriber may place a heat source near the ONT or block air inlets to the ONT. Such actions may result in an environment causing the ONT to overheat, which can, in turn, disrupt communications for the ONT as well as other ONTs within an optical communications network.

### SUMMARY OF THE INVENTION

Example embodiments of the present invention provide a method and system for controlling behavior of a network device. At a given network node, at least one operating condition, such as temperature, is monitored. Based on this monitoring, the given network node determines whether the at least one operating condition has a potential or has been known to affect integrity of upstream communications adversely for at least one other network node. If so, the upstream communications for the given network node is controlled so as to preserve the integrity of upstream communications for the at least one other network node.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of a passive optical network in which embodiments of the present invention may be implemented.

FIG. 2 is a block diagram of an optical network terminal (ONT) including an embodiment of the present invention.

FIG. 3A is a table illustrating example operating condition thresholds and corresponding actions to modify behavior of network devices.

FIG. 3B is a table illustrating example operating condition thresholds and corresponding actions to reactivate network devices.

FIG. 4A is a flow diagram of a routine to modify network device behavior based on operating condition thresholds.

FIG. 4B is a flow diagram of a routine to recover a network device based on operating condition thresholds.

FIG. 5A is a flow diagram of a routine to monitor a network device in an emergency mode of operation.

FIG. 5B is a flow diagram of a routine to operate a network device in an emergency mode.

FIG. 5C is a flow diagram of a routine to monitor and operate a communications interface of a network device in an emergency mode.

### DETAILED DESCRIPTION OF THE INVENTION

A description of example embodiments of the invention follows.

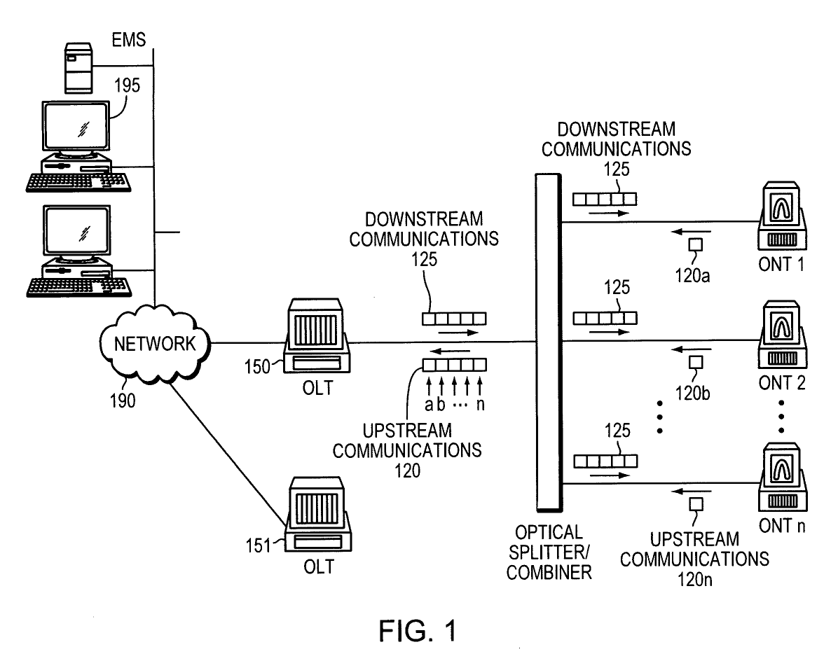

FIG. 1 is a block diagram of an optical network 100 having a number of network nodes, including optical network terminals (ONT) 130a-n, optical line terminal (OLT) 150, and element management system (EMS) 195. ONTs 130a-n support communications 120a-n, 125 between the OLT 150 and one or more networked devices (not shown), such as computer workstations, wireless network access points, and internet protocol television (IPTV) set-top boxes. The OLT 150 further routes such communications 120a-n, 125 across a network 190 (e.g., the Internet or additional optical channels) to and from a networked terminal or device, such as the element management system (EMS) 195, computer server, or a content service provider. Both upstream and downstream communications 120a-n, 125 include optical data bits that are transmitted in respective predefined timeslots. For example, in the case of a time division multiplexing (TDM) or time division multiple access (TDMA) communications protocol, communications data are placed into individual timeslots 120a-n of an upstream communications frame 120.

The OLT 150 transmits downstream communications 125 via optical line 121 to an optical splitter/combiner 115, which may be active or passive. The splitter/combiner 115 broadcasts the downstream communications 125 to the ONTs 130a-n, via respective optical lines 122a-n, as downstream communications 125. Due to a TDM or other multiplexing protocol, each ONT 130a-n may receive the entire downstream communications 125, or which one or more segments may be addressed to the receiving ONT (e.g., ONT 130a), and one or more other segments may be addressed to an other ONT (e.g., ONT 130b). The receiving ONT (e.g., ONT 130a) processes the received downstream communications (e.g., 125), and routes communications segments to connected devices (not shown) configured to receive those communications segments. The ONTs 130a-n may discard communications segments that are addressed to a different ONT or other device not in communication with the ONT 130a-n.

Each of the ONTs 130-n transmits upstream communications segments 120a-n, via respective optical lines 122a-n, to the optical splitter/combiner 115, which combines each of the segments 120a-n in the order received to transmit a combined upstream communications frame 120 to the OLT 150. Because the optical splitter/combiner 115, being a passive optical network (PON) component, combines the received segments 120a-n without compensating for delay or other faults in the received transmission, proper timing for the communications 120a-n must be maintained at each of the ONTs 130a-n. For example, if the splitter/combiner receives segment 120a later than the time slot allocated for it, it may instead coincide with the time slot allocated for segment 120b, causing a fault in the upstream communications 120. Moreover, such a delay may occur only from one ONT 130a-n, or at differing magnitudes at two or more ONTs 130a-n, which may result in two or more segments 120a-n to be received at the splitter/combiner 115 simultaneously, thereby causing further error in upstream communications 120.

In order to configure the ONTs 130a-n to transmit upstream communications 120 to coincide with respective allocated timeslots, the ONTs 130a-n may undergo a ranging process. Example ranging processes are described in further detail in ITU-T Recommendation G.983.1, “Broadband optical access systems based on passive optical networks (PON),” 2005, the entirety of which is incorporated by reference herein. In one example ranging process, the OLT 150 transmits a ranging request (not shown) to one OLT 130a. The ONT 130a, in response to the transmitted ranging request, transmits a ranging response (not shown). The OLT 150, having received the ranging response, determines a metric associated with the ranging response for use in connection with upstream communications between the OLT 150 and the ONT 130a. For example, a round-trip time may be determined, where the determined round-trip time represents a time from when the OLT 150 transmits the ranging request to the time the OLT 150 receives the ranging response. It should be understood that ranging cycles may be calculated other ways, such as a one-way trip time of a ranging request or a ranging response.

In one embodiment, the OLT 150 sets at least one parameter, used in connection with upstream communications between the OLT 150 and the ONT 130a, based on at least one metric associated with the ranging response. For example, the OLT 150, based on the round-trip time, may set an equalization delay. The OLT 150 may then send the ONT 130a the equalization delay or command the ONT 130a to set an internal parameter based on the equalization delay. During later communications with the OLT, the ONT 130a, in turn, waits for a time according to the equalization delay before sending upstream communications data (e.g., segment 120a). In one embodiment, the ONT 130a uses the equalization delay to have the upstream communications segment 120a reach in the OLT 150 during a predefined timeslot relative to upstream communications data from other ONTs 130b, 130n, such that upstream communications 120 from the ONTs 130a-n do not coincide. Each of the ONTs 130a-n may undergo a ranging process such as the process described above, resulting in each ONT 130a-n being configured to transmit upstream communications segments 120a-n such that they are received at the optical splitter/combiner at a respective allocated timeslot. The particular ranging configuration of each ONT 130a-n may depend on a number of factors, such as the length of the connecting optical line 122a-n and operating conditions at the ONT 130a-n.

Once an ONT 130a-n has been ranged, however, a number of factors may alter the delay after which the splitter/combiner 115 receives a communications segment 125, thereby causing a fault in upstream communications 120 as described above. For example, an ONT 130a may be implemented in an environment having varying ambient temperatures or extreme temperatures that affect operation of the ONT 130a. The ONT 130a may be located in an enclosed space, such as a sealed cabinet, with other ONTs 130b-n, and thus be prone to overheating due to poor air circulation. Such conditions, as well as other conditions (e.g., a computational error by an ONT) may cause a delay in an upstream communications segment 120a-n not compensated by the ranging process. Moreover, because an unduly delayed segment 120a-n may arrive at a timeslot allocated for another segment 120a-n, a faulty ONT 130a-n may adversely affect upstream communications of another ONT 130a-n, even if the affected ONT is operating properly.

Example embodiments of the present invention provide operational management of networked devices to preserve integrity of upstream communications. With regard to the optical network 100, for example, each ONT 130a-n, as well as other network terminals, may be configured to monitor one or more local operating conditions. Operating conditions may include the temperature of one or more components within a given ONT 130a, the temperature of a location at or near the ONT 130a, or the length of time for which those locations or components have been at or above a particular temperature. The ONT 130a may then compare those operating conditions to operational thresholds or a record of past operation (historical data) to determine whether the ONT 130a may affect adversely the integrity of upstream communications for the ONT 130a or for at least one other ONT 130b or other network node. In making this determination, the ONT 130a may analyze data from multiple sources, including historical information (i.e., a record of past operating conditions correlated with ONT performance (e.g., failure) or upstream communications), current weather, forecast information, time of day, time of year, type of components in the ONT 130a, geographical location, deployment information (e.g., type of building or enclosure), and supported upstream services. Based on this determination, the given ONT 130a may control behavior of its upstream communications 120a to preserve the integrity of upstream communications 120b for the at least one other ONT 130b. Alternatively, the given ONT 130a may report such determination to the OLT 150, EMS 195, or other ONT 130b, where the determination is used to control the behavior of upstream communications for the other ONT 130b to preserve the integrity of upstream communications 120 for the given ONT 130a.

Embodiments of the invention may be implemented at any of a number of network nodes, including ONTs, OLTs and supervisory nodes, such as an EMS. The parallel communications path of the network nodes may be configured to support a time division multiple access (TDMA) protocol. Monitored operating conditions may be internal or external to the network nodes, and can be monitored at the network node itself, a node receiving upstream communications from the given network node, or a node receiving data containing the upstream communications. Likewise, control over the behavior of the network node (including upstream communications and other corrective actions) may be exercised at the given network node, an upstream network node, or a supervisory node. This control may include disabling an upstream transmitter, reducing upstream communications, and disabling multiple internal devices in the given network node.

In further embodiments, the network node or other node may correlate current and historical operating conditions to determine a probability of the operating conditions to affect integrity of the upstream communications for at least one other network node. A notification of the operating conditions may be reported to at least one of the following: a supervisory node, service provider, craft person, customer, end user, subscriber of the given network node, manufacturer, third party vendor, and emergency services personnel. Such reporting may be completed by the given network node or another node.

In still further embodiments, historical information of the monitored operating conditions may be maintained and updated based on current operating conditions, thereby improving predictions of the potential of future operating conditions to affect the integrity of the network node or upstream communications adversely. In response to such operating conditions, embodiments of the invention may take corrective actions including declaring an alarm, modifying the behavior of upstream communications, and shutting down at least a portion of the network node.

In further embodiments, a network node may support an “emergency mode” of operation. Entering an emergency mode may include overriding the controlled network node behavior or other corrective actions. If one or more services is disabled at the network node, embodiments of the invention may monitor a network interface for received downstream communications, and may reactivate a network interface for upstream communications. For such upstream communications, the network node may first undergo a re-ranging process in order to avoid affecting upstream communications for other nodes. For a particular network interface such as a plain old telephone service (POTS) interface, embodiments of the invention may monitor an off hook condition of the interface. If an off-hook condition is detected, then the network node re-ranges the interface for upstream communications, and enables the interface for at least the duration of a call.

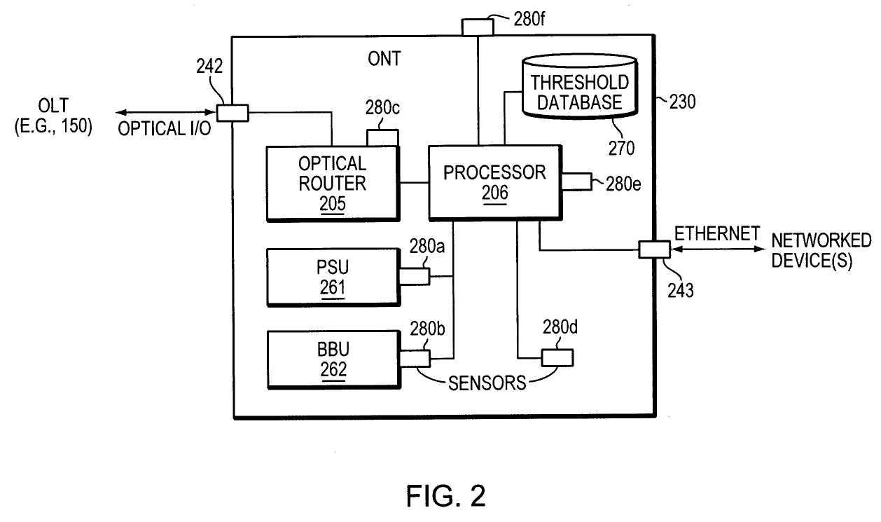

FIG. 2 is a block diagram of an ONT 230 configured according to an example embodiment of the present invention. ONTs 130a-n, in FIG. 1, may be configured in a manner similar to the ONT 230. The ONT 230 communicates upstream with an OLT (e.g., OLT 150 in FIG. 1) or other network device via upstream optical port 242, which is coupled to an optical router 205 for receiving and transmitting optical communications at the port 242. Those communications may be received by the processor 206 in a digital mode, which in turn routes communications downstream to one or more networked devices (not shown) via an Ethernet port 243. Power to the ONT 230 may be provided primarily by a power supply unit (PSU) 261, and, in a case of PSU 261 failure, by a battery backup unit 262.

A number of sensors 280a-f are positioned at different locations within and outside the enclosure of the ONT 230. For example, sensor 280a is positioned at the PSU 261, sensor 280b is positioned at the BBU 262, sensor 280c is positioned at the optical router 205, sensor 280d is positioned within the enclosure of the ONT 230, sensor 280e is positioned at the processor 206, and sensor 280f is positioned external to the enclosure. Other sensors may be positioned relative to other locations within or external to the enclosure in addition to (or in place of) the sensors 280a-f. Sensors 280a-f may be configured to detect temperature, humidity, radiation, combustion or other operating conditions relative to their respective positions. The processor 206 may also perform calculations using the sensor 280a-f readings to determine additional operating conditions, such as an amount of time that a sensor reading is at, above or below a given temperature.

The processor 206 collects readings from the sensors 280a-f continuously, periodically or in response to an instruction. The processor 206 may also detect computational faults at the optical router 205 or the processor 206, particularly those faults that may adversely affect upstream communications, such as hardware or software failures. For example, a delay in processing egress communications at the optical router 205, if not corrected, may cause the router 205 to transmit optical communications via the upstream port 242 at a time that is not properly synchronized with an allocated time slot determined by the ranging process. Such a fault may adversely affect upstream communications for the ONT 206, as well as upstream communications for another ONT (not shown) or other network device as described above.

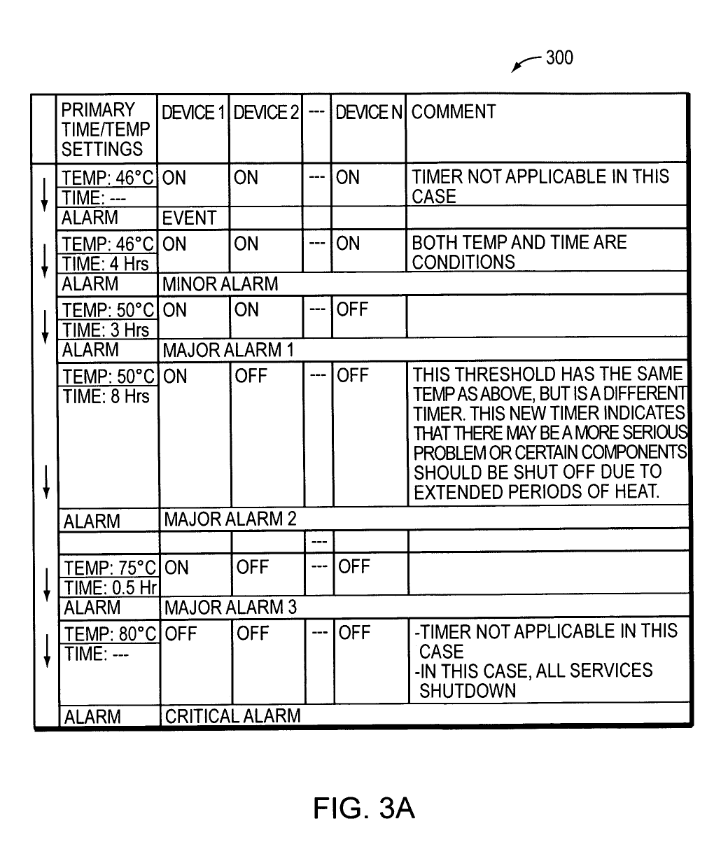

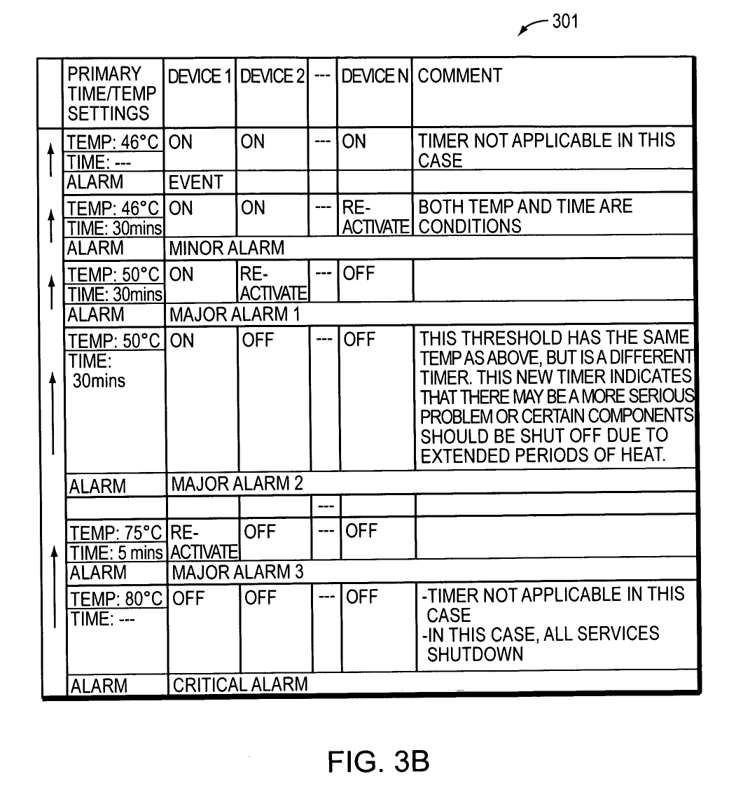

In determining whether the detected operating conditions have the potential to adversely affect upstream communications, the processor 205 compares the operating conditions to one or more operation thresholds stored at the threshold database 270. Example operation thresholds are described in further detail below with reference to FIGS. 3A-B. In one such example, the processor 206 may determine, based on present and recent readings from sensor 280c, that the optical router 205 has been above a given temperature for a given time. The processor 206 then searches the threshold database 270 to determine whether these operating conditions (i.e., temperature over time) reaches or surpasses an operating threshold. In addition to detected operating conditions, the ONT 230 may implement other data to determine whether a threshold has been met or surpassed, such as historical data on operating conditions and corresponding failures. Such additional data may be compared against corresponding data integral to the thresholds.

If an operating threshold is met or surpassed, the processor 206 may perform a corrective action corresponding to the operating threshold, as indicated in the threshold database. Corrective actions can include disabling one or more devices (e.g., optical router 205, PSU 261, BBU 262) at the ONT 230, modifying operations of such devices (e.g., entering a “low power” mode or reducing a rate of operation), disabling services, or disabling one or more streams of communications through the ONT 230. For example, the ONT 230 may take corrective action by disabling some or all upstream communications, which have the potential to interfere with upstream communications for other ONTs, while maintaining downstream communications, which may include instructions from an OLT or another ONT to enable upstream communications.

Alternatively, or in addition, the ONT 230 can communicate with other ONTs to coordinate such corrective actions. For example, the ONT 230 may have priority in communications over another ONT, such that—even if the ONT 230 is found to interfere with communications at the other ONT—it is preferable to receive communications from the ONT 230 rather than the other ONT. In such a case, the ONT 230 may communicate with the upstream OLT and/or one or more other ONTs to ensure that the ONT's 230 upstream communication is maintained. In doing so, the other ONT(s) may take corrective action as described above, including disabling upstream communications that may interfere with upstream communications of the ONT 230. Likewise, the upstream OLT (e.g., OLT 150 in FIG. 1) may reconfigure the timing of received upstream communications so as to compensate for any delay by the ONT 230.

Conversely, the ONT 230 may defer to upstream communications for another ONT, regardless of whether the ONT 230 is operating properly. For example, the ONT 230 may receive communications from the other ONT indicating that the other ONT is likely to delay its upstream communications. In response, the ONT 230 can take one or more corrective actions, including modifying or disabling its upstream communications, so as not to interfere with upstream communications of the other ONT.

FIG. 3A is a table 300 illustrating example operating condition thresholds and corresponding actions for modifying behavior of network devices, such as the ONTs 130a-n, 230 of FIGS. 1 and 2. In this table 300, the operating conditions for each threshold include time and temperature, and corrective actions include disabling one or more devices (“device 1,” “device 2,” etc.) at the ONT. Alternatively, the table may include any of the operating conditions and corrective actions described above with respect to FIG. 2.

In utilizing the operating condition thresholds of this table 300, an ONT measures a temperature at one or more sensors at the ONT (e.g., a sensor at an optical router, or an average of multiple sensors), and maintains a record of that temperature over time. The ONT then compares these operating conditions to the operating condition thresholds of the table 300. If the operating conditions match or surpass an operating condition threshold, then the ONT takes a corresponding corrective action. For example, if the ONT detects a temperature of 46° C. for any length of time, the ONT records an “event.” The event may be forwarded to an EMS or other system for monitoring the operation of the ONT. If the ONT detects a temperature of 46° C. for 4 hours, then the ONT declares a minor alarm, which may also be forwarded for monitoring. If the ONT detect a temperature of 50° C. for 3 hours, it declares a major alarm, and disables “device N” within the ONT. Disabling a device within the ONT may be directed to one or more objectives, including 1) preventing damage to that device due to overheating; 2) preventing damage to other devices by allowing that device to cool; 3) maintaining the integrity of upstream communications of other devices within the ONT by maintaining those devices operating at an acceptable temperature; and 4) if disabling the device also disables upstream communications, then the integrity of upstream communications for another ONT may be maintained.

The table 300 continues with further thresholds indicating more severe operating temperatures at the ONT, directing the ONT to declare additional alarms and disable additional devices. Ultimately, if the ONT detects a temperature of 80° C. for any period of time, a critical alarm is declared, and all devices in the ONT are disabled.

FIG. 3B is a table 301 illustrating example operating condition thresholds and corresponding actions for reactivating network devices of network devices, such as the ONTs 130a-n, 230 of FIGS. 1 and 2. An ONT may utilize both table 300 of FIG. 3A and table 301 of FIG. 3B simultaneously: The ONT will determine whether its operating conditions meet or exceed the thresholds in table 300 to disable devices, while also determine whether the operating conditions meet or exceed the thresholds in table 301 to reactivate devices. The operating conditions meet or exceed the thresholds of table 301 when the temperature is at or below the threshold temperature for at least the specified time. For example, if the ONT was previously at 80° C., then all devices may be disabled. If the ONT detects a temperature at or under 75° C. for at least 5 minutes, then the ONT will reactivate “device 1.” Alternatively, the table 301 could be configured to instruct the ONT to reactivate any devices, services (e.g., upstream communications) or other operations that have been disabled. As temperature continues to decrease and additional thresholds in table 301 are met, the ONT may reactivate additional devices, until all devices are operational.

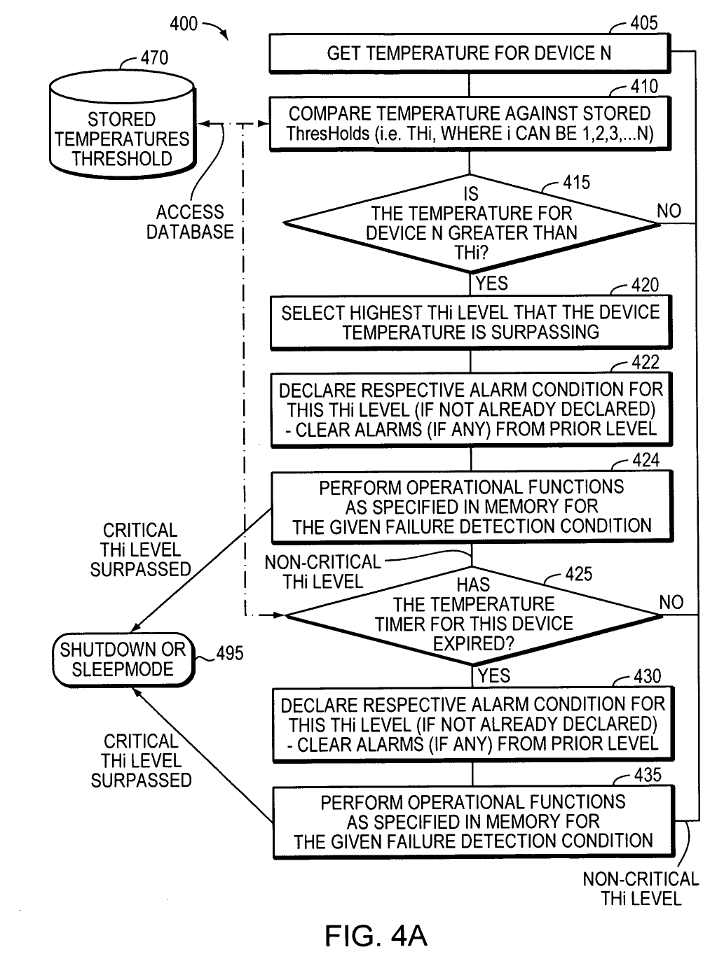

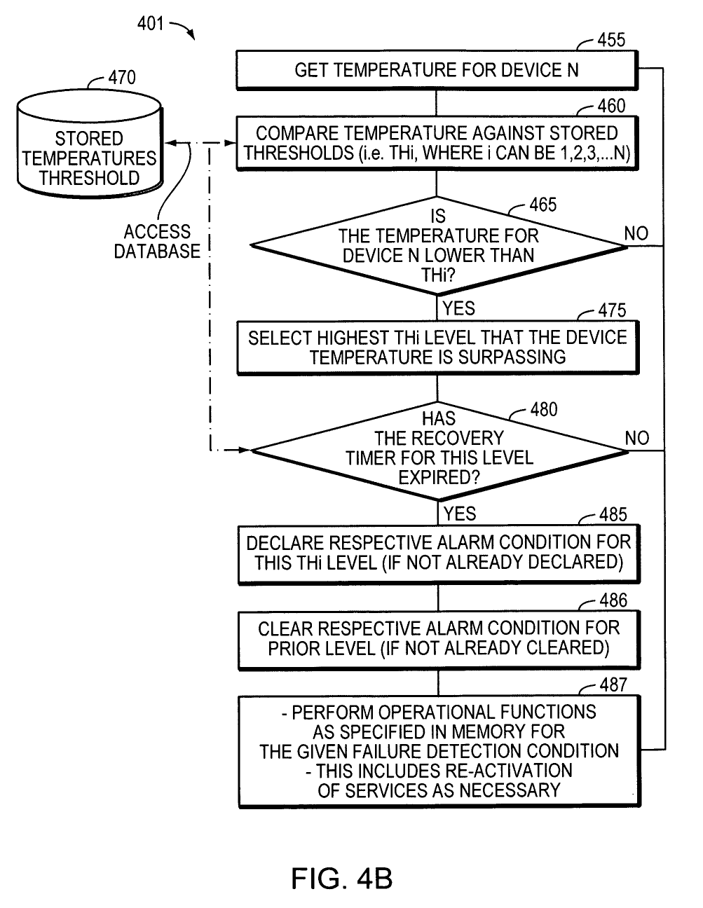

FIG. 4A is a flow diagram of a routine 400 for modifying network device behavior based on operating condition thresholds. The routine may be performed by an ONT, such as the ONTs 130a-n, 230 of FIGS. 1 and 2, and may implement operating condition thresholds as illustrated in FIG. 3A.

In one example embodiment, an ONT determines the temperature of a device or other area within or outside of the ONT according to a corresponding sensor (405). In other examples, operating conditions other than temperature can be substituted for temperature. The ONT compares the detected temperature against stored thresholds THi (e.g., TH1, TH2 . . . THn), which may be stored at a threshold database 470 (410). If the temperature is greater than THi (415), then the ONT selects the highest THi level that the device temperature is surpassing (420). Accordingly the ONT declares a respective alarm condition corresponding to this THi level (422), and performs any corresponding corrective actions (e.g., disabling a device or modifying upstream communications) specified in the threshold database 470 (424). If the corrective action requires that the device or ONT shut down or enter an emergency or disabled mode, then the ONT will do so (495).

Some thresholds THi may have a temporal component (e.g., THi is surpassed at a threshold temperature over a given length of time). For such thresholds, if the temperature has been met or surpassed, the ONT also determines whether the timer for THi has expired (425). If so, then a corresponding alarm (if any) is declared (430), the ONT undertakes any corresponding corrective action (435), which may include entering a disabled or emergency mode (495). The routine 400 may be repeated continually or periodically to determine whether additional thresholds have been met or surpassed.

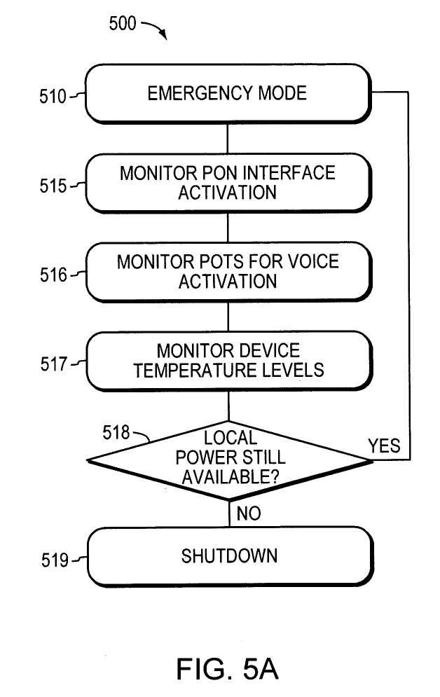

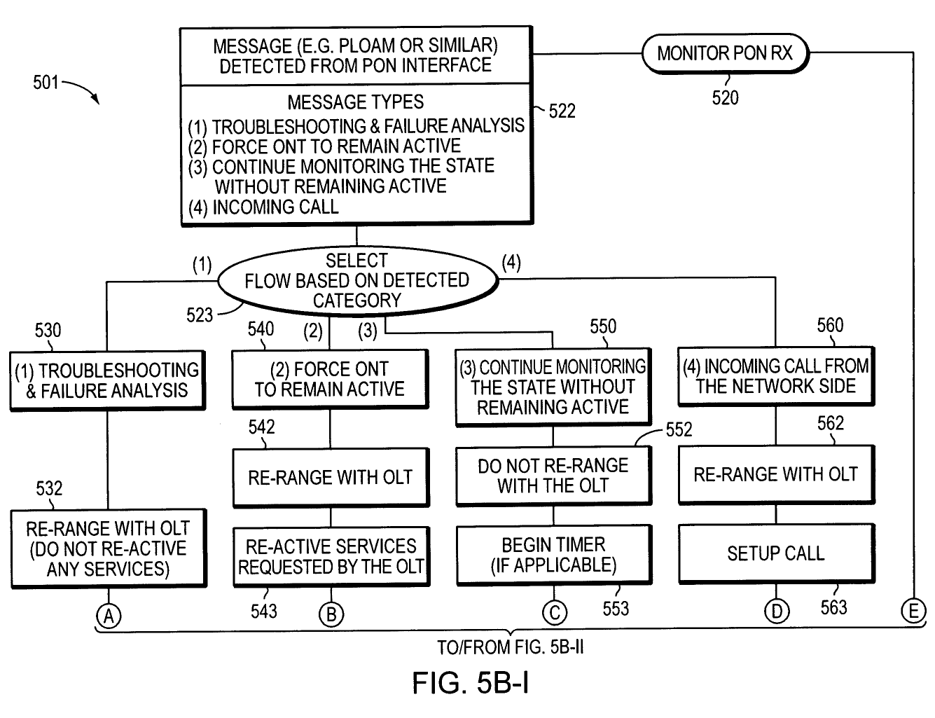

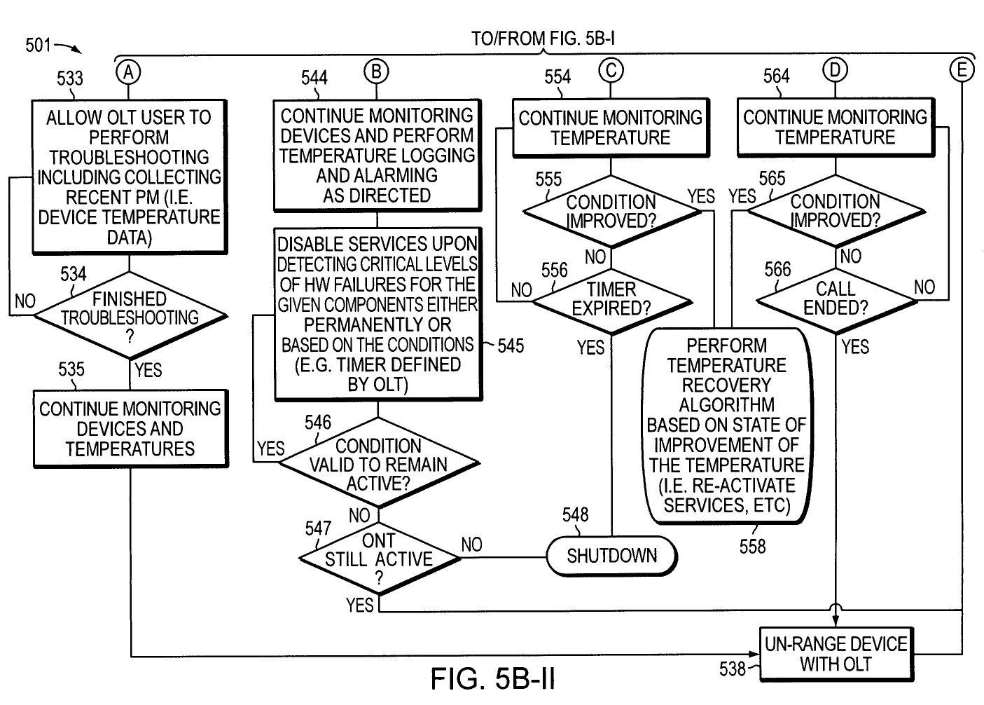

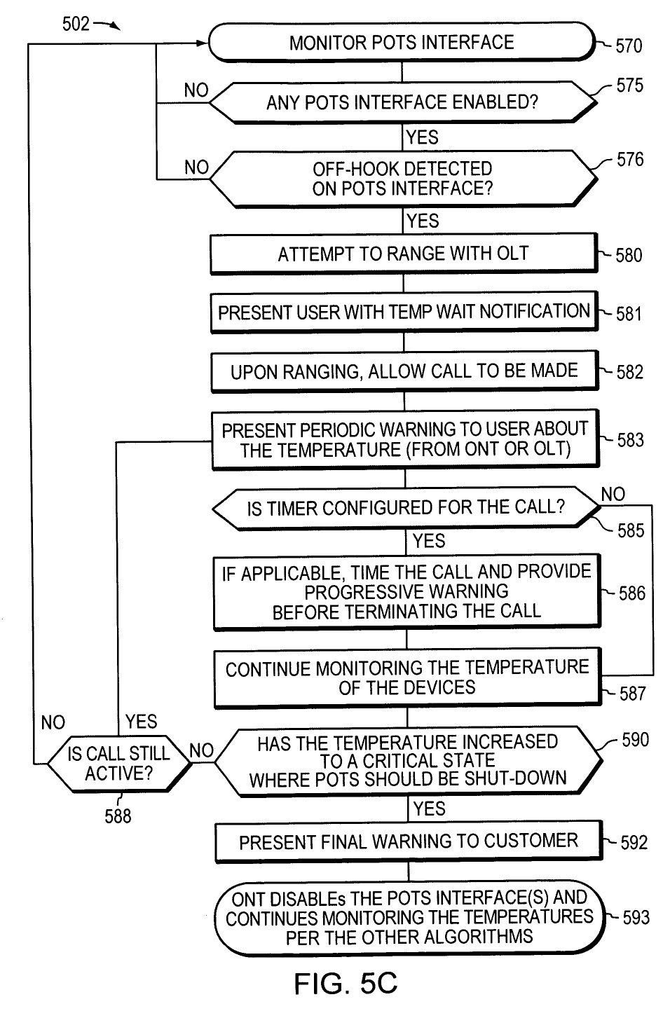

FIG. 4B is a flow diagram of a routine 401 for recovering a network device based on operating condition thresholds. The routine may be performed by an ONT, such as the ONTs 130a-n, 230 of FIGS. 1 and 2, and may implement operating condition thresholds as illustrated in FIG. 3B. At the beginning of the routine 401, the ONT has taken a corrective action such as disabling one or more devices or services, or modifying the behavior of network communications. The ONT may also be in an “emergency” mode, as described below with respect to FIGS. 5A-C. Through the routine 401, the ONT determines whether detected conditions meet a particular threshold so as to enable reversing the prior corrective action (e.g., by reactivating a device or service or resuming upstream communications).

In one example embodiment, the ONT determines the temperature of a device or other area within or outside of the ONT according to a corresponding sensor (455). The temperature may correspond specifically to a device or service that has been disabled or modified by the aforementioned corrective action. Alternatively, operating conditions other than temperature can be substituted for temperature. The ONT compares the detected temperature against stored thresholds THi (e.g., TH1, TH2 . . . THn), which may be stored at a threshold database 470 (460). If the temperature is greater than THi (465), then the ONT selects the highest THi level that the device temperature is surpassing (475). To recover the device or service at this THi level, the temporal component of the threshold must also be satisfied. Thus, the ONT may set a timer, a “recovery timer,” that tracks the amount of time the temperature has met or surpassed the THi level. If the recovery timer has expired (480), then the ONT declares a respective alarm condition for this threshold, if not already declared (485), while clearing any alarm conditions set by a previous threshold (486). Further, the ONT performs any respective recovery actions, which may include reversing previous corrective actions, corresponding to the threshold (487). The ONT may then repeat the routine 401 continually or periodically to determine whether additional thresholds have been met or surpassed. Simultaneously, the ONT may also be performing a routine, such as the routine 400 in FIG. 4A, to determine whether more severe alarms or additional corrective actions should be taken at the ONT, such as in response to further degraded operational conditions (e.g., increased temperature).

FIG. 5A is a flow diagram of a routine for monitoring at a network device in an emergency mode of operation. In response to surpassing a threshold or declaring a given alarm as described above with respect to FIGS. 1-4B, an ONT may enter an “emergency mode.” In such a mode, the ONT may perform one or more operations notwithstanding the detected operating conditions of the ONT. An emergency mode can have a number of applications. For example, if an ONT modifies its behavior of upstream communications, perhaps by disabling some or all devices or services, a subscriber may still require network access. This network access can include receiving an incoming call, initiating a call, or maintaining a connection to the internet or other network. Further, an emergency mode may force the ONT to remain wholly or partially active to perform other operations, or may enable troubleshooting and failure analysis. Although an emergency mode may enable some operations notwithstanding modified or disabled devices, operations in the emergency mode may be controlled so as to minimize ONT failure and other adverse effects.

In this routine 500, an ONT enters an emergency mode (510) in response to an alarm, or as a component of a corrective action initiated in response to detected operating conditions. While in emergency mode, the ONT continuously or periodically performs one or more monitoring functions. The ONT may monitor a passive optical network (PON) interface for activation (515). The PON interface may be activated at the ONT (e.g., an emergency override) or by an upstream network node for initiating communications with the ONT (see FIG. 5B). The ONT may also monitor a “plain old telephone service” (POTS) interface to determine whether the interface has been activated, such as by receiving a voice call or a subscriber-initiated call (516) (see FIG. 5C). The ONT may also monitor temperatures or other operating conditions as described above with regard to FIGS. 2-4B (517). This monitoring may be utilized, as above, to determine whether operating conditions meet or surpass thresholds. The ONT can also determine whether operations in the emergency mode are exacerbating the operating conditions (e.g., causing further temperature increases), hindering recovery of the ONT (e.g., by maintaining the temperature at an undesirable level), or enabling ONT recovery (e.g., by facilitating a decrease in temperature). While monitoring the ONT interfaces and operating conditions, the ONT also verifies whether local power is still available via a PSU or BBU (518). If local power is no longer available, the ONT enters a sequence to shutdown, thereby terminating all functions at the ONT (519).

FIG. 5B is a flow diagram of a routine 501 for operating a network device in an emergency mode. The ONT monitors a PON interface for messages communicated from an upstream node (e.g., an OLT or EMS) (520). The ONT may also detect messages or commands initiated by a subscriber at the ONT. If such a message is detected (522), the ONT responds according to message type (523): [1] Troubleshooting and Failure Analysis (530); [2] Force ONT to remain active (540); [3] Continue monitoring operating conditions without remaining active (550); and [4] Incoming Call (560).

In response to a message requesting troubleshooting and failure analysis (530), the ONT re-ranges with the OLT in order to compensate for any difference in propagation delay caused by changed operating conditions, without reactivating any services (532). Once ranging is complete, a network administrator or other user may communicate with the ONT, via the OLT, to perform troubleshooting operations (533). The troubleshooting can include collecting operating conditions, error messages and other characteristics at the OLT, which are communicated upstream to an EMS or other network node (534). Once the troubleshooting and data collection is complete (534), the ONT may continue monitoring operating conditions (535). The ONT may then be un-ranged so as to prevent further upstream communications from adversely affecting upstream communications from other ONTs (538).

In response to a message forcing the ONT to remain active (540), the ONT re-ranges with the OLT (542), re-activates services requested by the OLT or subscriber at the ONT (543), and continues monitoring operating conditions and determining whether those conditions meet or surpass operating condition thresholds (544). Thus, the ONT may continue to support limited or more substantial services, which may be considered critical, despite potentially adverse affects to the ONT and to upstream communications for other ONTs. However, if the ONT detects that other, predetermined thresholds have been met or surpassed, such as hardware failures or critically high temperatures, then the ONT will disable those services in order to prevent further failures (545). If operating conditions again become acceptable (546), the ONT may resume the requested services (544); otherwise, if the ONT is no longer active (547), the ONT enters a shutdown state (548).

In response to a message to continue monitoring operating conditions without remaining active (550), the ONT refrains from re-ranging with the OLT (552), and may set a timer to restrict the time allotted for continued monitoring (553). The ONT continues to monitor operating conditions and determining whether those conditions meet or surpass any applicable operating condition thresholds (554). If such a change is detected (555) (e.g., lower temperature), then the ONT may initiate a recovery routine (e.g., a routine 401 as in FIG. 4B according to the thresholds 301 in FIG. 3B) in order to reactivate devices or services at the ONT (558). If operating conditions have not changed so as to facilitate such a recovery upon expiration of the timer (556), then the ONT may initiate a shutdown.

In response to an incoming call from an upstream node (560), the ONT re-ranges with the OLT (562) and establishes the call between the upstream node and the subscriber (563). The ONT also continues to monitor temperature (566). If the ONT detects changed operating conditions so as to allow device or service recovery (565), then the ONT initiates a recovery routine (558), which may occur while the call is established. Yet if the call terminates (566) while operating conditions remain unsuitable for recovery, then the ONT un-ranges with the OLT (538), and returns to monitoring the PON interface for additional messages or calls (520).

FIG. 5C is a flow diagram of a routine 502 for monitoring and operating a POTS interface of a network device in an emergency mode. The POTS interface may support voice channels, session initiation protocol (SIP) (wireline or wireless/WiFi) channels, or other interfaces configured for service at the ONT. In an emergency mode of operation, the ONT may monitor and enable the POTS interface in order to support a voice call or network access despite a limited availability of other services. For example, a subscriber may call a network administrator or operator at the EMS in order to resolve failures at the ONT. The subscriber may also need to make a critical call unrelated to resolving issues at the ONT. The example illustrated in FIG. 5C pertains to a voice call, but embodiments of the invention may be configured in a similar manner to provide access to other channels of communication, such as network (e.g., internet) access.

In an emergency mode, or in response to an alarm, corrective action or other event, the ONT monitors the POTS interface continuously or periodically (570). If the POTS interface is enabled (575), and an OFF-hook is detected at the POTS interface (576) (e.g., a subscriber unhooks a telephone receiver), then the ONT attempts to range with the OLT (580). This ranging may serve as an update to a previous ranging configuration, the previous configuration being made obsolete by a change in temperature or other conditions resulting in the emergency mode. The subscriber receives a temporary “wait” notification, via an audio or video message, to indicate that a call or network access will be available within a given time (581). If the ranging is successful, the ONT utilizes the new ranging configuration for upstream communication toward an OLT, and allows a call to be made (582).

In response to dial tone or other confirmation that a call may be made, a subscriber initiates a call, for example by dialing a telephone number. The ONT continues monitoring operating conditions throughout the call, and presents periodic warnings to the subscriber regarding the emergency mode of operation (583). Alternatively, the OLT may present such warnings by including them in the downstream audio of the call itself. The OLT may detect when the ONT is in the emergency state due to messages from the ONT, interruption of service, or re-ranging to set up the emergency call. A timer may also be configured so as to limit the length of the call, thereby preventing damage to the ONT or adverse effects to the upstream communication for other ONTs due to the call. If such a timer is configured (585), then the ONT will terminate the call after the timer expires, providing progressive (e.g., increasingly frequent) warning messages (586). Notwithstanding a timer configuration, the ONT continues to monitor its operating conditions (587), and evaluates whether the operating conditions have surpassed a threshold or reached a critical state warranting the POTS interface to be shut down (590). If so, the ONT presents a final warning message to the subscriber (592), and then disables the POTS interface, thereby terminating any call that is still active (593), and continues to monitor operating conditions as directed by any monitoring processes (593). Otherwise, if such a threshold is not met, and a call is still active (588), then the ONT continues to present periodic warning messages to the subscriber throughout the call (583).

It should be understood that the block diagram of FIGS. 1 and 3 and the flow diagrams of FIGS. 4A-5C are examples that can include more or fewer components, be partitioned into subunits, or be implemented in different combinations. Moreover, the flow diagrams may be implemented in hardware, firmware, or software. If implemented in software, the software may be written in any software language suitable for use in networks and network devices as illustrated in FIGS. 1-2. The software may be embodied on any form of computer readable medium, such as RAM, ROM, or magnetic or optical disk, and loaded and executed by generic or custom processor(s).

While this invention has been particularly shown and described with references to example embodiments thereof, it will be understood by those skilled in the art that various changes in form and details may be made therein without departing from the scope of the invention encompassed by the appended claims.

What is claimed is:

1. A method of controlling behavior of a network node, comprising:
monitoring at least one operating condition of a given network node;
determining whether the at least one operating condition has a potential or has been known to affect adversely integrity of upstream communications for at least one other network node; and
controlling behavior of upstream communications for the given network node to preserve integrity of upstream communications for the at least one other network node.

2. The method of claim 1, wherein the at least one other network node has a parallel communications path as the given network node.

3. The method of claim 2, wherein the parallel communications path is configured to support a time division multiple access (TDMA) protocol.

4. The method of claim 2, wherein the network node and the at least one other network node include optical line terminals (OLTs) associated with a passive optical network (PON).

5. The method of claim 1, wherein the at least one operating condition is internal to the network node.

6. The method of claim 5, where in the at least one operating condition is temperature at the network node.

7. The method of claim 1, wherein the monitoring includes monitoring at least one of: the given network node, a node receiving upstream communications from the given network node, and a node receiving data containing the upstream communications.

8. The method of claim 1, wherein the determining is based on at least one of: historical information, forecast information, current information, time of day, time of year, type of components in the given network node, geographical location, deployment information, and supported upstream services.

9. The method of claim 1, wherein controlling behavior of upstream communications occurs at one of: the given network node, an upstream network node, or a supervisory node.

10. The method of claim 1, wherein controlling behavior of upstream communications includes at least one of: disabling an upstream transmitter, reducing upstream communications, or disabling multiple internal devices in the given network node.

11. The method of claim 1, wherein determining includes correlating current and historical operating conditions to determine a probability of the operating conditions to affect integrity of the upstream communications for at least one other network node.

12. The method of claim 1, further comprising reporting a notification of the operating condition to at least one of the following: a supervisory node, service provider, craft person, customer, end user, subscriber of the given network node, manufacturer, third party vendor, and emergency services personnel.

13. The method of claim 12, wherein the reporting is performed by the given network node or an upstream node.

14. The method of claim 1 further comprising updating historical information to predict potential of future operating conditions to effect upstream communications adversely.

15. The method of claim 1 wherein determining includes comparing operating conditions against at least one threshold of operating conditions.

16. The method of claim 15 wherein the at least one threshold corresponds to at least one corrective action, the at least one corrective action being at least one of: declaring an alarm, modifying the behavior of upstream communications, and shutting down at least a portion of the network node.

17. The method of claim 15 wherein the at least one threshold includes multiple thresholds, each of the multiple thresholds corresponding to different operating conditions and corrective actions.

18. The method of claim 1 wherein controlling further includes overriding the controlling in response to declaring an emergency mode of operation.

19. The method of claim 1 wherein controlling includes disabling all services at the network node.

20. The method of claim 19 further comprising reactivating a network interface for upstream communications.

21. The method of claim 20 wherein reactivating includes re-ranging the network interface.

22. The method of claim 1 further comprising:
monitoring an off-hook condition at a plain old telephone service (POTS) interface;
re-ranging the network node with an upstream node; and
enabling the POTS interface at least for a duration of a call.

23. A method of controlling behavior of a network node, comprising:
monitoring performance of a given network node relative to at least one operating condition of the given network node;
determining a probability of failure of the given network node based on the at least one operating condition and historical performance data regarding the at least one operating condition; and
controlling, based on the probability of failure, behavior of at least one other network node to preserve integrity of the given network node.

24. The method of claim 23, wherein controlling behavior of the at least one other network node includes controlling behavior of upstream communications for the at least one other network node.

25. The method of claim 24, wherein controlling behavior of upstream communications includes modifying timing of the upstream communications.
